(19) United States
(12) Patent Application Publication
(10) Pub. No.: US 2011/0271534 A1
(43) Pub. Date: Nov. 10, 2011

(54) ADJUSTABLE RAZOR AND METHOD

(76) Inventor: Dennis Briganti, Delray Beach, FL (US)

(21) Appl. No.: 12/773,199

(22) Filed: May 4, 2010

(51) Int. Cl. B26B 21/52; B26B 21/14

(52) U.S. Cl. 30/535; 132/200

(57) ABSTRACT

An adjustable razor include a handle member, an interior member and a razor head. The handle member includes a body having an elongated receptacle, a first opening, and a second opening spaced from the first opening. The interior member is telescopingly disposed within the handle member receptacle. The interior member includes a depressable button configured to releasably engage the handle member first opening and handle member second opening. The interior member is movable between a retracted position, where the button releasably engages the handle member first opening, and an extended position, where the button releasably engages the handle member second opening. The razor head coupled to the interior member.

### BACKGROUND OF INVENTION

This application relates to shaving razors. More particularly, this application relates to razor assemblies that are adjustable to permit a user to reach areas that are typically difficult to reach.

### SUMMARY

For various aesthetic and hygienic reasons, individuals have had the need to remove unsightly or unwanted hair from various parts of the body. Shaving razors are the most common and popular method by which this is accomplished. Shaving razors are typically designed with relatively short handles. If an individual is obese, elderly or has some degenerative ailment, such as arthritis, shaving hard to reach areas of the body or appendage extremities requires the user to assume uncomfortable, awkward positions. Such awkward positioning during shaving greatly increases risk of injury, particularly on wet slippery surfaces, such as a bathtub. Current designs preclude personal grooming of certain areas for such individuals.

This application provides an adjustable razor that permits a user to reach areas that are typically difficult to reach. In particular, an adjustable razor comprising: a handle member comprising a body having an elongated receptacle, a first opening, and a second opening spaced from the first opening; an interior member telescopingly disposed within the handle member receptacle, the interior member having a depressable button configured to releasably engage the handle member first opening and handle member second opening, wherein the interior member is movable between a retracted position, where the button releasably engages the handle member first opening, and an extended position, where the button releasably engages the handle member second opening; and a razor head coupled to the interior member.

This application also discloses a method for shaving comprising: providing an adjustable razor comprising: a handle member comprising a body having an elongated receptacle, a first opening, and a second opening spaced from the first opening; an interior member telescopingly disposed within the handle member receptacle, the interior member having a depressable button configured to releasably engage the handle member first opening and handle member second opening, wherein the interior portion is movable between a retracted position, where the button releasably engages the handle member first opening, and an extended position, where the button releasably engages the handle member second opening; and a razor head coupled to the interior member; depressing the button; moving the interior member from one of the retracted position and extended position to the other of the retracted position and extended position; and applying the razor head against skin for shaving.

### BRIEF DESCRIPTION OF THE DRAWINGS

The drawings, when considered in connection with the following description, are presented for the purpose of facilitating an understanding of the subject matter sought to be protected.

FIG. 1 is a schematic perspective view of an adjustable razor;

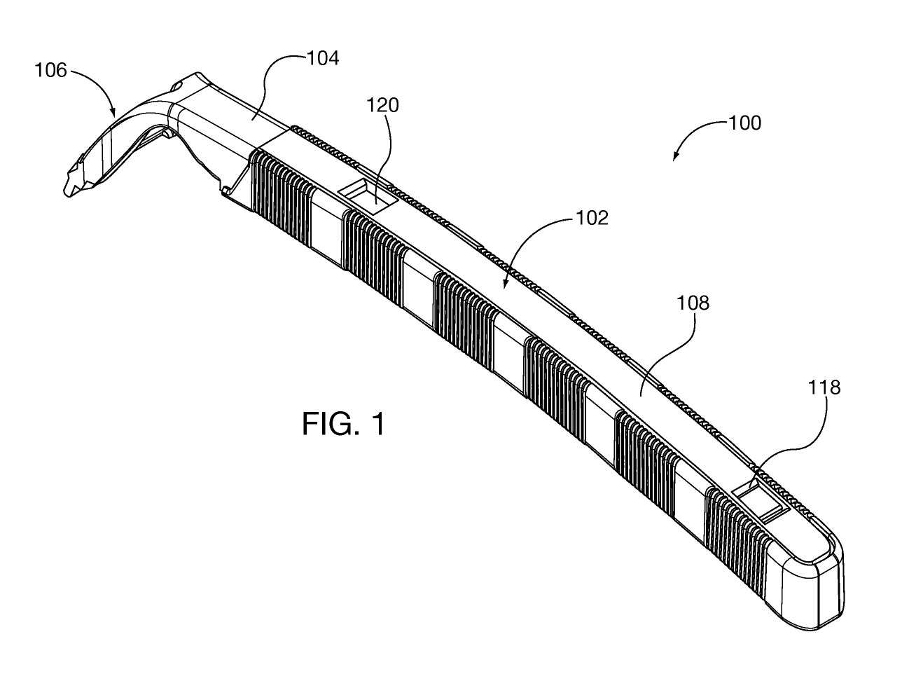

FIG. 2A is a schematic perspective view of an handle member of an adjustable razor;

FIG. 2B is a schematic cross-sectional view of the handle member of FIG. 2A;

FIG. 3 is a schematic perspective view of an interior portion of an adjustable razor;

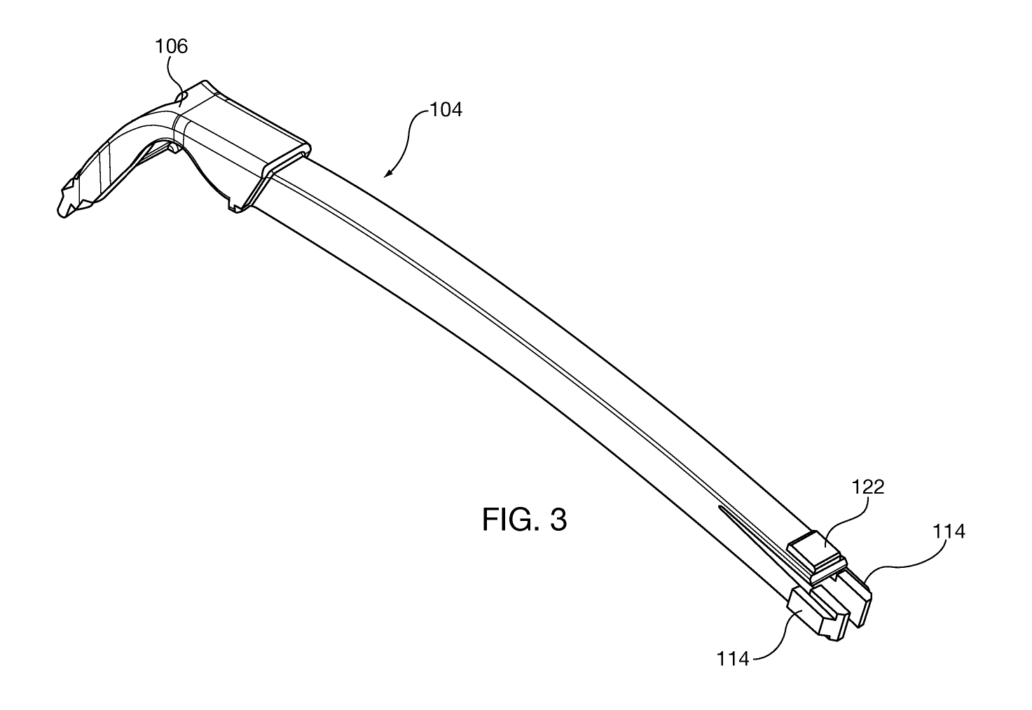

FIG. 4 is a schematic side view of an interior portion of an adjustable razor;

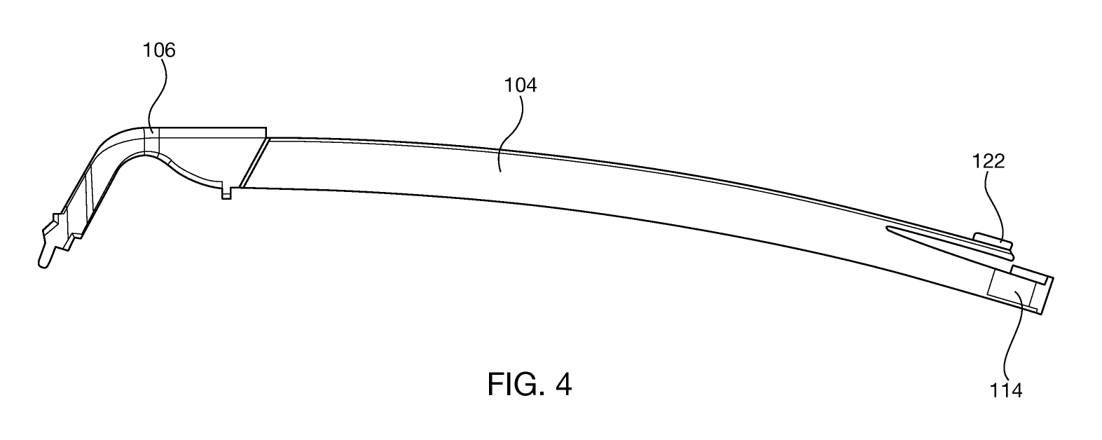

FIG. 5 is a schematic side view of an initial engagement of an interior portion with a handle member of an adjustable razor;

FIG. 6 is a schematic side view of an adjustable razor in an extended position; and

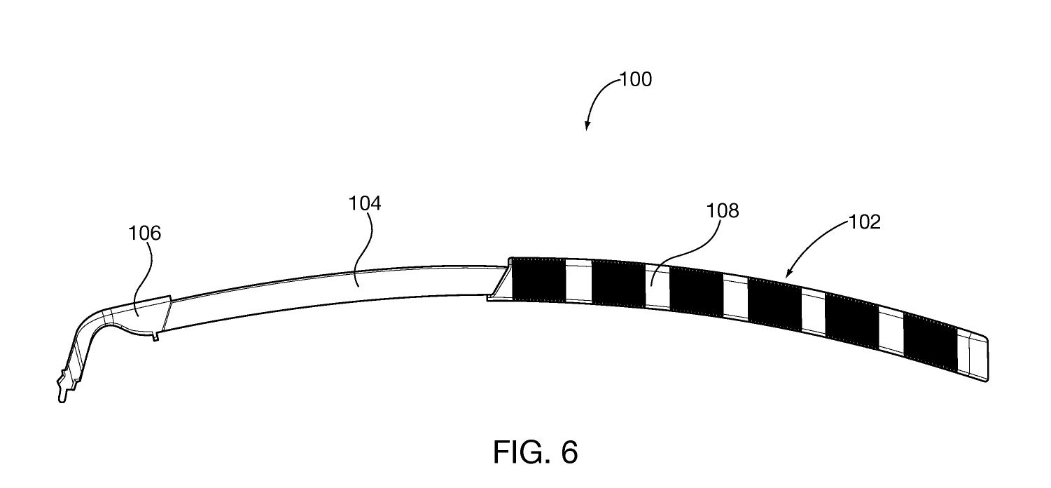

FIG. 7 is a schematic side view of an adjustable razor in a retracted position.

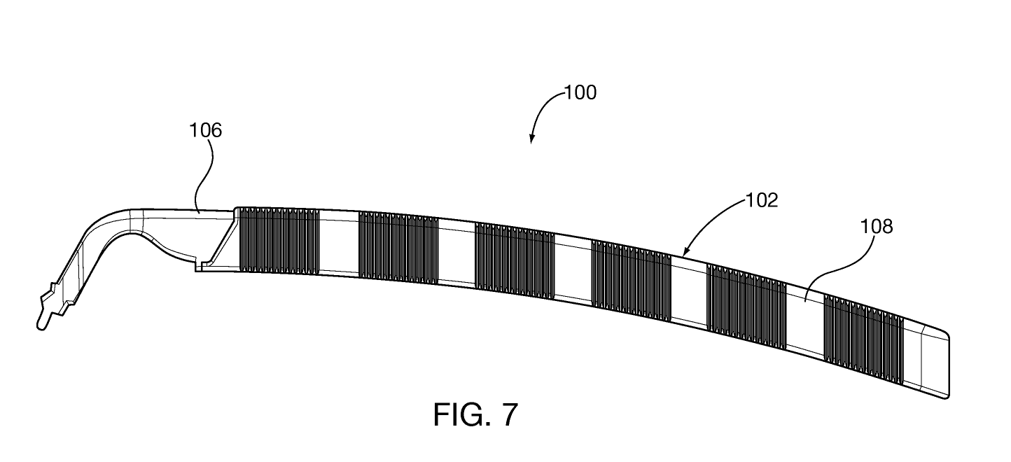

### DETAILED DESCRIPTION

Referring now to the FIGS., an illustrative adjustable razor 100 is shown. The razor 100 generally includes a handle member 102, an interior member 104, and a razor head 106. The adjustable razor 100 may be formed from any suitable material, or combination thereof, including but not limited to, metal, polymer, composite, etc.

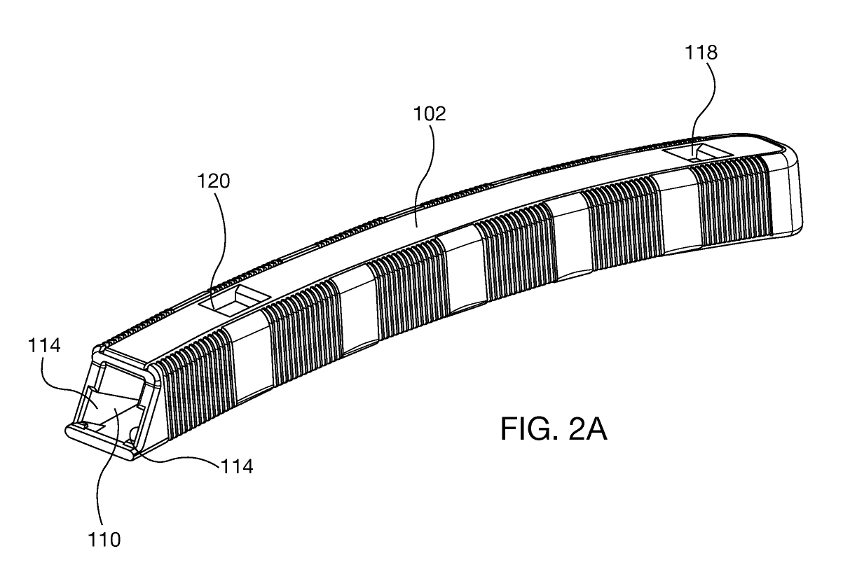

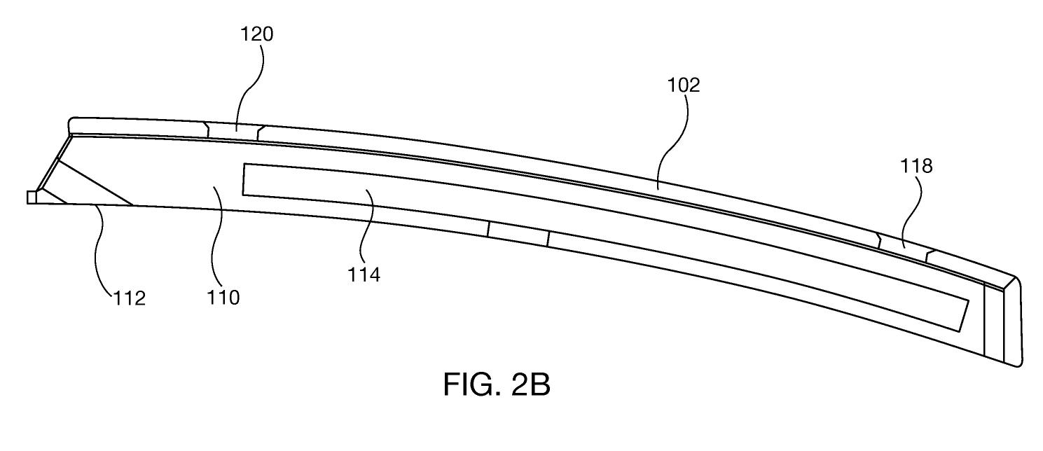

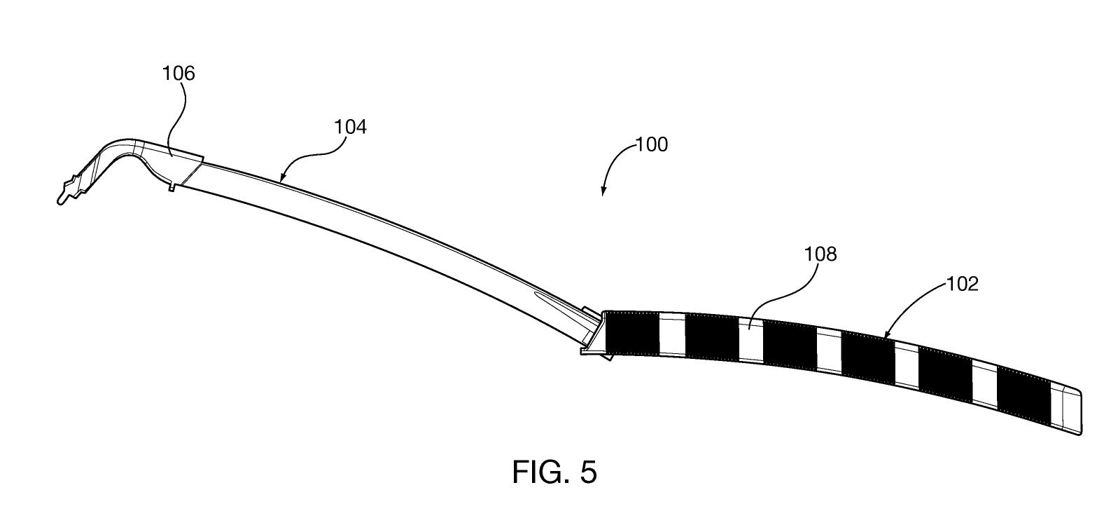

The handle member 102 includes a body 108. The exterior of the body 108 may include any suitable feature, including but not limited to grip portions, hooks or openings for hanging the razor 100, etc. The body 108 also includes an elongated receptacle 110 adapted to receive the interior member 104. In one embodiment, as shown in FIG. 2B, the receptacle 110 has a arcuate profile cross-section. However, it will be appreciated that the receptacle 110 may have any suitable profile cross-section and remain within the scope of the present disclosure. The receptacle 110 may also include a ramped portion 112 configured to assist in the initial telescopic engagement of the interior portion 104 with the handle member 102 (see, e.g., FIG. 5). The handle member 102 may also include one or more guide channels 114 adapted to slidingly engage one or more corresponding guide tabs 116 of the interior member 104.

The handle member 102 also includes a first opening 118 and a second opening 120 spaced from the first opening 118. As will be discussed further below, the openings 118, 120 are adapted to releasably engage the button 122 of the interior member 104. In one embodiment, one or more of the openings 118, 120 are substantially perpendicular to the handle member receptacle 110. In another embodiment, one or more of the openings 118, 120 are substantially perpendicular to a line tangential to the receptacle 110. It will be appreciated that the openings 118, 120 may have any suitable configuration and remain within the scope of the present disclosure. Also, while the present handle member 102 includes two openings 118, 120 for engaging the interior member button 122, it will be appreciated that the handle member 102 may include any suitable number of such openings and remain within the scope of the present disclosure.

The interior portion 104 is configured to be telescopically and slidingly received within the handle member receptacle 110. The interior portion includes a button 122. The button 122 is configured to releaseably engage the openings 118, 120 of the handle member 102. In one embodiment, the button 122 is selectively movable between an engaged position, where the button is engaged with an handle member opening 118, 120, and a disengaged position, where the button 122 is disengaged from an opening 118, 120. Also, in one embodiment, the button 122 is biased to the engaged position such that when the interior portion 104 is moved to the extended or retracted position, the button 122 engages the corresponding opening 118, 120. The interior portion 104 is selectively movable between a retracted position, where the button 122 releasably engages the handle member first opening 118, and an extended position, where the button 122 releasably engages the handle member second opening 120.

In one embodiment, the interior member 104 includes one or more guide tabs 116 configured to slidingly engage corresponding one or more handle member guide channel 114. The guide tabs 116 may be flexible to assist in the initial disposal of the interior portion 104 within the handle member receptacle 110 whereafter the guide tabs 116 engage and remain engaged with the channels 114 unless or until the interior portion 104 is removed from the handle member receptacle 110. In one embodiment, the interior member 104 has an arcuate profile cross-section; however, it will be appreciated that the interior portion may have any suitable profile cross-section and remain within the scope of the present disclosure.

The razor head 106 may be any suitable razor head 106. The razor head 106 may include any suitable number of razor blades configured to cut hair. The razor head 106 may also include other features, including but not limited to moisturizing strip(s), safety elements or any other suitable feature as is known in the art. For example, and without limitation, the razor head 106 may include replaceable razor cartridges. The razor head 106 is coupled to the distal end of the interior portion 104. The razor head 106 may be coupled to the interior member 104 via any suitable means or device, including but not limited to mechanical fasteners, adhesive, bonding, welding, or any other suitable device or means. It will be appreciated that the term coupled is intended to be broad enough to encompass situations where the razor head 106 is integral with the interior member 104.

In use, the interior portion 104 is disposed within the handle member receptacle 110 such that each of the guide tabs 116 slidingly engages a corresponding handle member guide channel 114. The interior portion 104 may then be moved to one of the retracted position or extended position such that the button 122 is in releasable engagement with the corresponding handle member opening 118, 120 such that the interior portion is locked in said position. The razor head 106 may then be applied against the skin of a user for shaving. If desired, the user may depress the button 122 to disengage the button 122 from the opening 118, 120 whereby the interior portion 104 may then be moved to the other of the retracted position and extended position where button 122 may then releasable engage a corresponding opening 118, 120 such that the interior portion 104 is locked in said position. The razor head 106 may then be reapplied against skin for shaving. A user may selectively move the interior portion 104 between the extended position and retracted position as described above and as needed throughout the shaving process to ensure all areas are adequately shaven.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. An adjustable razor comprising:
a handle member comprising a body having an elongated receptacle, a first opening, and a second opening spaced from the first opening;
an interior member telescopingly disposed within the handle member receptacle, the interior member having a depressable button configured to releasably engage the handle member first opening and handle member second opening, wherein the interior member is movable between a retracted position, where the button releasably engages the handle member first opening, and an extended position, where the button releasably engages the handle member second opening; and
a razor head coupled to the interior member.

2. The adjustable razor of claim 1 wherein the button is movable between an engaged position to a disengaged position.

3. The adjustable razor of claim 2 wherein the button is biased to the engaged position.

4. The adjustable razor of claim 1 wherein the handle member further comprises a guide channel and wherein the interior member further comprises a guide tab configured to slidingly engage the handle member guide channel.

5. The adjustable razor of claim 1 wherein the handle member further comprises a ramped portion configured to assist the initial telescopic engagement of the interior member and the handle portion receptacle.

6. The adjustable razor of claim 1 wherein at least one of the first opening and second opening is substantially perpendicular to the handle member receptacle.

7. The adjustable razor of claim 1 wherein the receptacle has an arcuate cross-section

8. The adjustable razor of claim 1 wherein the interior member has an arcuate cross-section.

9. A method for shaving comprising:
providing an adjustable razor comprising:
a handle member comprising a body having an elongated receptacle, a first opening, and a second opening spaced from the first opening;
an interior member telescopingly disposed within the handle member receptacle, the interior member having a depressable button configured to releasably engage the handle member first opening and handle member second opening, wherein the interior portion is movable between a retracted position, where the button releasably engages the handle member first opening, and an extended position, where the button releasably engages the handle member second opening; and
a razor head coupled to the interior member;
depressing the button;
moving the interior member from one of the retracted position and extended position to the other of the retracted position and extended position; and
applying the razor head against skin for shaving.

10. The method of claim 9 wherein the button is movable between an engaged position to a disengaged position.

11. The method of claim 10 wherein the button is biased to the engaged position.

12. The method of claim 9 wherein the handle member further comprises a guide channel and wherein the interior member further comprises a guide tab configured to slidingly engage the handle member guide channel.

13. The method of claim 9 wherein the handle member further comprises a ramped portion configured to assist the initial telescopic engagement of the interior member and the handle portion receptacle.

14. The method of claim 9 wherein at least one of the first opening and second opening is substantially perpendicular to the receptacle.

15. The method of claim 9 wherein the receptacle has an arcuate cross-section

16. The method of claim 9 wherein the interior member has an arcuate cross-section.
